(19) United States
(12) Patent Application Publication
(10) Pub. No.: US 2007/0101208 A1
(43) Pub. Date: May 3, 2007

(54) System and method for reporting errors

(76) Inventor: Julia Mohr, Edingen-Neckarhausen (DE)

Correspondence Address: KENYON & KENYON LLP, ONE BROADWAY, NEW YORK, NY, 10004, US

(21) Appl. No.: 11/262,546

(22) Filed: Oct. 28, 2005

(51) Int. Cl. G06F 11/00

(52) U.S. Cl. 714/57

(57) ABSTRACT

An error reporting mechanism, displayed in a user interface, allows a user to proactively and efficiently communicate error reports to a system administrator. The error reporting mechanism, when selected by the user, causes the user interface to display a text input box for the user to enter descriptive information about the error encountered. The user creates an error report by choosing to send the descriptive information. The error report incorporates descriptions entered by the user as well as system information for the corresponding application stored by a central processor. The error report is sent to a system administrator console via a communication network.

### BACKGROUND

The present invention generally relates to a mechanism for reporting system errors to an administrator, and more specifically to user-initiated instant communication of error reports to an administrator from a user's work environment.

Various existing error reporting schemes allow a user to communicate with a system administrator when he/she encounters technical difficulties during operation. In the most basic form of error reporting, the user stops his/her work while trying to locate an administrator by telephone to report system anomaly and repair the problem. In an alternative scheme, the user sends an administrator an email message from his/her desktop email application to report system failures by describing the error and the application involved. Some software applications include the capability to prompt the user to send a generic system-generated email message to report an application error.

While existing error reporting schemes attempt to maintain an open line of communication between a user and a system administrator, they often fail to accommodate the user's urgent needs for several reasons. First, in a reporting scheme where a user must communicate with a system administrator by telephone to resolve technical difficulties, the user must stop his/her work mid-stream to report the error. In organizations where the system administrator is not constantly available or there are many technical support personnel available, locating the system administrator or identifying the right person to report to can be time consuming and frustrating.

Secondly, in an existing reporting scheme where a user sends an email message to a system administrator via a desktop email application, the user must not only inform the administrator that the error occurred, but also provide the administrator with relevant technical system information for the corresponding application. This can be a difficult and demanding task if the user is new to the application or is not familiar with background technical information for the application.

Thirdly, in an existing reporting scheme where a user is prompted by the application to send a system-generated generic error report, the user has no control in terms of the type of information that is being sent to the administrator. In this scenario, the user cannot communicate to the administrator personalized descriptions, such as what he/she thinks the error is, reasons for the error, or ways to remedy the error. Rather, the user must passively send a message communicating non-descriptive information generated by the system.

The present invention overcomes the disadvantages of existing systems by allowing users to proactively and efficiently report system errors. More specifically, in an exemplary embodiment, the present invention integrates an error reporting mechanism in a user's work environment, which, when selected by the user, causes the work environment to display an input text box. The user creates an error report by entering textual descriptions of the error. System information for the application is automatically captured in the error report when the user proceeds to send the report to a system administrator.

### BRIEF DESCRIPTION OF THE DRAWINGS

FIG. 1 is a block diagram of a computer system for reporting errors comprising a user interface coupled with a processor, connected to a system administrator console.

FIG. 2 is a block diagram illustrating one embodiment of the error reporting mechanism as an instant messaging dialogue box.

FIG. 3. is a screen shot illustrating an exemplary view of an active work environment presenting an error reporting mechanism, before the user selects the error reporting mechanism.

FIG. 4 is another screen shot illustrating an exemplary view of an active work environment presenting an error reporting mechanism, after the user selects the error reporting mechanism, which causes the work environment to display a pop-in text box.

### DETAILED DESCRIPTION

Embodiments of the present invention provide error reporting mechanisms in highly interactive software applications, such as SAP's ERP Human Capital Management module, CRM Improving Order Management application, and mySAP Supplier Relationship Management program. According to these embodiments, a running work environment integrates an error reporting mechanism that enables a user to proactively communicate technical difficulties or anomalies to system administrators. When the user encounters a system error and chooses to report the instance to an administrator, the user selects the available error reporting mechanism, which causes the work environment to display a text input box. To create an error report, the user enters descriptions of the error in the text input box as he/she desires. The error report, containing text entered by the user and system-generated information regarding the running application, is communicated to an administrator. The administrator receives the error report at his/her console, checks the application to confirm the error, and reconfigures the system accordingly.

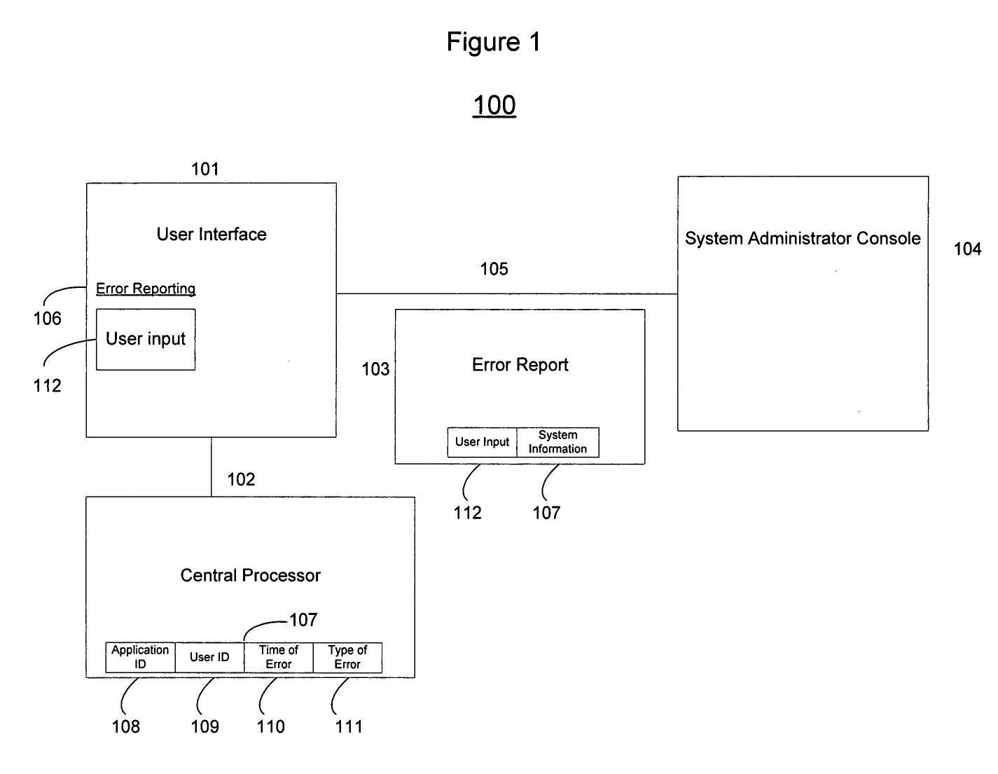

FIG. 1 is a block diagram of one embodiment of the present invention. It shows a computer system 100 including a user interface for an active work environment 101, coupled to a central processor 102; an error report 103 containing information entered by user 112 and information generated by central processor 107, communicated to system administrator console 104 via network 105. User interface 101 displays an error reporting mechanism 106 containing a text box for user input 112. Central processor 102 stores system information 107 for each application in which an error has occurred, including application identification 108, user identification 109, time of error 110, and type of error 111. Specifically, application identification 108 indicates in which application and version the error occurred; user identification 109 identifies the active user when the error occurred; time of error 110 captures when the error took place; and type of error 111 communicates the category of the error that occurred. When the user creates error report 103 by entering user input 112, central processor 102 incorporates system information 107 in error report 103. Consequently, error report 103, containing both user input 112 and system information 107, is communicated to system administrator console 104 via network 105.

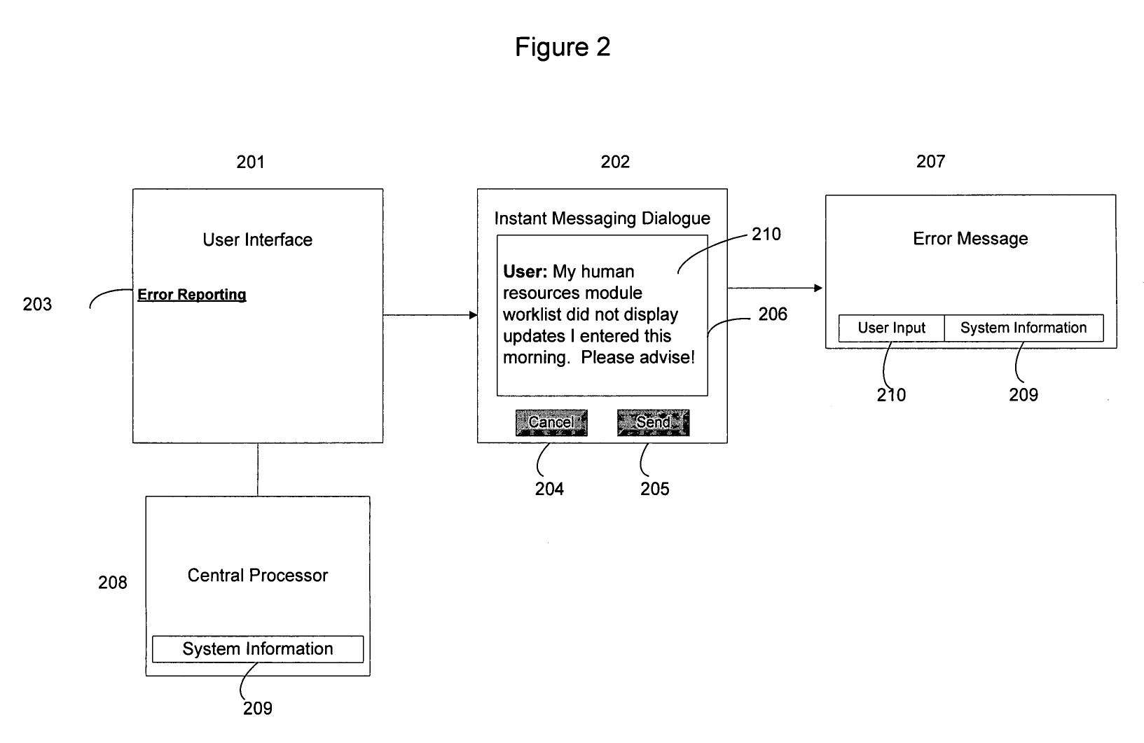

FIG. 2 is a block diagram illustrating one embodiment of an error reporting mechanism. Error reporting mechanism 203 is displayed on user interface 201. When the user selects error reporting mechanism 203, an instant messaging dialogue box 202 appears, containing action buttons “Cancel” 204 and “Send” 205. The user enters text describing error 210 in dialogue input box 206. To cancel the action of creating error message 207, the user clicks “Cancel” button 204. To create and send an error message 207, the user clicks “Send” button 205. Error message 207 includes text describing error 210 and system information 209 generated by central processor 208.

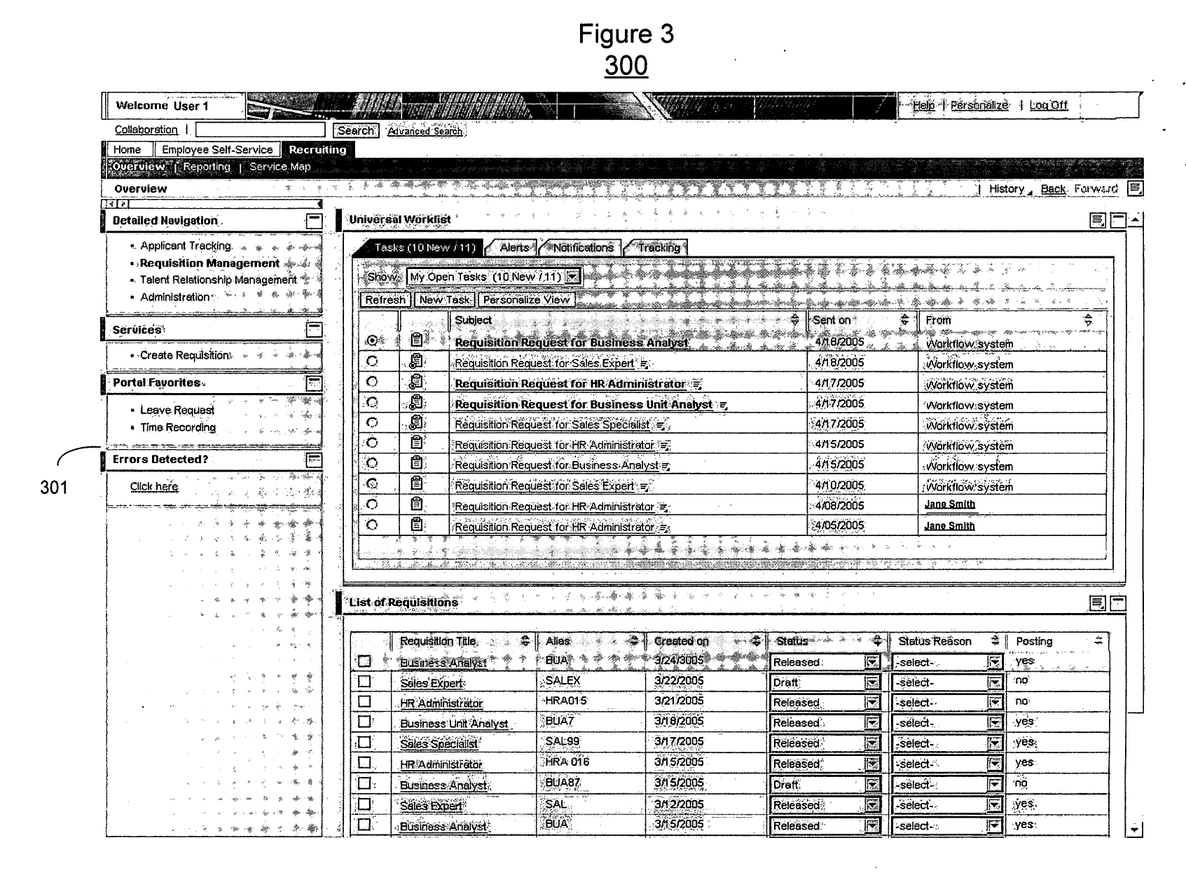

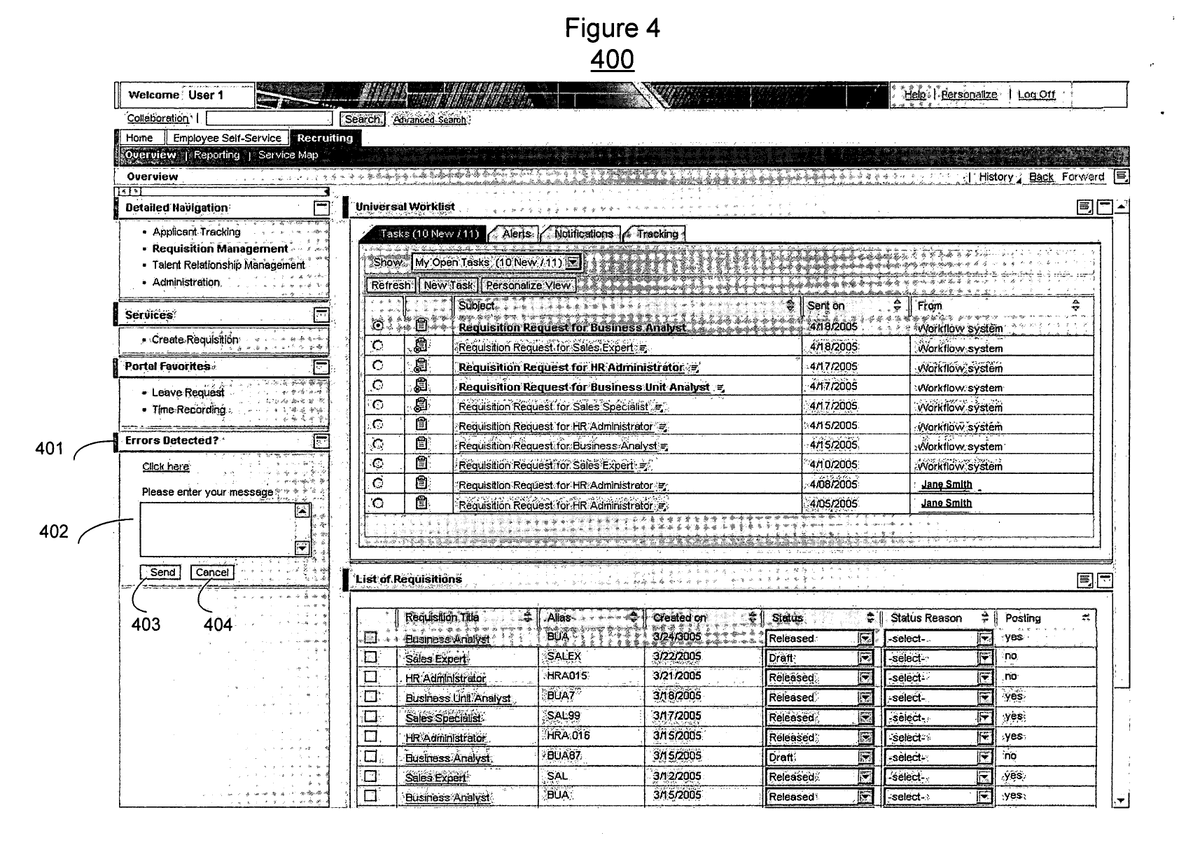

FIG. 3 is a screen shot of one embodiment of the present invention before the user chooses to report an error. User interface 300 constantly displays error reporting mechanism 301, labeled “Errors Detected?,” in a navigation panel, typically appearing on the left side of the computer screen. When the user clicks the hyperlink, labeled “Click here,” a pop-in text box appears, as shown in FIG. 4.

In an alternative embodiment, error reporting mechanism 301 is hidden from user interface 300 at the user's choice.

In another alternative embodiment, error reporting mechanism 301 is displayed at the top of the computer screen, in the button row.

FIG. 4 is a screen shot of one embodiment of the present invention after the user chooses to report an error. After the user selects the “Click here” hyperlink in FIG. 3, pop-in text box 402 appears in error reporting mechanism 401 in the navigation panel displayed on the left side of the computer screen. In other words, pop-in text box 402 appears within the same display level as user interface 300. Subsequent to the user entering the error description in pop-in text box 402, the user sends the error report by clicking “Send” action button 403, or the user cancels the error report by clicking “Cancel” action button 404.

In an alternative embodiment, after the user selects the “Click here” hyperlink in FIG. 3, a pop-up text box appears on user interface 400 for the user to compose an error report.

Alternatively, after the user selects the “Click here” hyperlink in FIG. 3, an instant messaging dialogue box appears on user interface 400, enabling the user to communicate an error report and maintain a real-time conversation with a system administrator.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A computer system for reporting system errors, comprising:
a user interface provided to present to a user an error reporting mechanism, which, when selected by the user, causes the user interface to display a text input box for the user to enter text information;
a central processor coupled to the user interface, wherein the central processor stores system information for an application providing the user interface, and creates an error report containing text information entered by the user and the stored system information corresponding to the application providing the user interface;
a network for communicating the error report to a system administrator; and
a system administration device for receiving the error report.

2. The system of claim 1, wherein the user interface constantly displays the error reporting mechanism in a navigation panel.

3. The system of claim 1, wherein the user interface hides the error reporting mechanism at the user's choice.

4. The system of claim 1, wherein the text input box is a pop-in text box.

5. The system of claim 1, wherein the text input box is a pop-up text box.

6. The system of claim 1, wherein the error reporting mechanism, when selected by the user, causes the user interface to display an instant messaging dialogue box and starts an instant messaging session with the system administrator.

7. The system of claim 1, wherein the text input box appears within the same display level as the user interface.

8. A computer system for reporting system errors, comprising:
means for presenting to a user an error reporting mechanism, which, when selected by the user, causes a user interface to display a text input box for the user to enter text information;
means for storing system information for an application providing the user interface and creating an error report containing text information entered by the user and the stored system information corresponding to the application providing the user interface;
means for communicating the error report to a system administrator; and
means for receiving the error report.

9. The system of claim 8, further comprising:
means for constantly displaying the error reporting mechanism.

10. The system of claim 8, further comprising:
means for hiding the error reporting mechanism at the user's choice.

11. The system of claim 8, further comprising:
means for providing the text input box as a pop-in text box.

12. The system of claim 8, further comprising:
means for providing the text input box as a pop-up text box.

13. The system of claim 8, wherein the error reporting mechanism, when selected by the user, causes the user interface to display an instant messaging dialogue box and starts an instant messaging session with the system administrator.

14. The system of claim 8, further comprising:
means for displaying the text input box within the same display level as the user interface.

15. A method for reporting errors, comprising:
presenting to a user an error reporting mechanism, which, when selected by the user, causes a user interface to display a text input box for the user to enter text information;
creating an error report containing text information entered by the user and stored system information corresponding to an application providing the user interface;
communicating the error report to a system administrator; and
receiving the error report.

16. The method of claim 15, further comprising:
displaying the text input box within the same display level as the user interface.

17. A computer readable medium having program instructions stored thereon that, when executed, cause a computer system to:
present to a user an error reporting mechanism in a user interface, which, when selected by the user, causes the user interface to display a text input box for the user to enter text information,
store system information for an application providing the user interface,
create an error report containing text information entered by the user and the stored system information corresponding to the application providing the user interface,
communicate the error report to a system administrator, and
receive the error report.

18. The medium of claim 17, wherein the error reporting mechanism is constantly displayed in the user interface.

19. The medium of claim 17, wherein the error reporting mechanism is hidden from the user interface at the user's choice.

20. The medium of claim 17, wherein the text input box is a pop-in text box.

21. The medium of claim 17, wherein the text input box is a pop-up text box.

22. The medium of claim 17, wherein the error reporting mechanism, when selected by the user, causes the user interface to display an instant messaging dialogue box and starts an instant messaging session with the system administrator.

23. The medium of claim 17, wherein the text input box appears within the same display level as the user interface.
